(19) United States
(12) Patent Application Publication
(10) Pub. No.: US 2003/0120747 A1
(43) Pub. Date: Jun. 26, 2003

(54) Thin client network system and data transmitting method therefor

(75) Inventor: Yong-Jae Kim, Seoul (KR)

Correspondence Address: STAAS & HALSEY LLP, 700 11TH STREET, NW, SUITE 500, WASHINGTON, DC, 20001, US

(73) Assignee: Samsung Electronics Co., Ltd., Suwon-city (KR)

(21) Appl. No.: 10/185,069

(22) Filed: Jul. 1, 2002

(30) Foreign Application Priority Data
Dec. 20, 2001 (KR) 2001-81814

(51) Int. Cl. G06F 15/16

(52) U.S. Cl. 709/217; 709/203

(57) ABSTRACT

A data transmitting method in a thin client network system including a thin client, and a server connected to the thin client through a network. An application program is executed on the server in response to a request of the thin client and results of the execution are transmitted to the thin client as graphic data. If a determination is made that the application program activated by the thin client includes moving picture data, the moving picture data is compressed with a lossy compression algorithm and data other than the moving picture data is compressed with a lossless compression algorithm before the compressed data is transmitted from the server to the thin client. Thus, a size of data transmitted from the server to the thin client is efficiently decreased.

### CROSS REFERENCE TO RELATED APPLICATIONS

This application claims the benefit of Korean Application No. 2001-81814 filed Dec. 20, 2001, in the Korean Patent Office, the disclosure of which is incorporated herein by reference.

### BACKGROUND OF THE INVENTION

1. Field of the Invention

The present invention relates to a thin client network system and a method of transmitting data for a thin client network system.

2. Description of the Related Art

A thin client indicates a terminal which includes only such components as are necessary for communicating data to a user and for communication with a server, and all computing is performed on the server.

Because the server employs Windows NT, Windows 2000, etc., as an operating system, the existing Windows application programs are usable by the thin client connected to the server. Further, a Windows application program installed in the server is usable by all thin clients connected to the server. Thus, in the thin client network system, managing, controlling and upgrading the software programs is convenient.

A process of transmitting graphic data from a server to a thin client will be described referring to FIGS. 1 and 2.

A thin client 10 accesses a server 20 provided with application programs such as a Windows media player, a word processor, etc., through a TCP/IP or IPX protocol (P10). After a simple authenticating procedure, the thin client 10 orders the application program provided in the server 20 to be executed (P20). An input signal is input through an input unit 13, such as a keyboard, a mouse, etc., of the thin client 10, and the input signal is transmitted by a client terminal 11 to the server 20 via a network 30, requesting execution of the application programs of the server 20. The server 20 runs the requested application program in response to the request of the thin client 10, and results of the execution such as computing, saving, etc., of the application programs are transmitted to the thin client 10 as graphic data through the network 30 (P30)]. The thin client 10 outputs the received graphic data to a monitor 19 (P40).

The connection and the data communication between the server 20 and the thin client 10 are achievable by ICA (independent computing architecture) designed by Citrix Corporation, RDP (remote desktop protocol) designed by Microsoft Corporation, or etc. Particularly, the ICA supports various operating systems such as DOS, OS/2, UNIX, JAVA, etc., and various hardware components, whereas the RDP supports Windows NT or Windows 2000 of Microsoft Corporation. However, the windows servers are employable with WinFrame or MetaFrame of Citrix Corporation.

According to the thin client network system, installing the application programs separately for each thin client 10 is not necessary. Further, many hardware components which are normally required in a self contained computer are not required in the thin client 10, thereby increasing a space utility and decreasing the cost of buying, maintaining and repairing the hardware components.

In the thin client network system, because data is transmitted from the server 20 to the thin client 10 through the network 30, it is desirable that the data is compressed in the server 20 before being transmitted to the thin client 10.

Generally, data compression does not affect the contents of the data even if the size of data is decreased. That is, the data compression decreases only the size of the data. Restoring the size of the compressed data is called data extraction. For example, if data is represented as “33333333”, it is compressed as “38” (“3” is repeated eight times). In this case, the data is reduced from 8 bytes to 2 bytes.

Algorithms for data compression are classified into lossless compression algorithms and lossy compression algorithms.

A lossless compression algorithm compresses data without loss of the data so as to restore the compressed data to the original data, but there is a limit to a compression rate of the lossless compression algorithm. Thus, a lossless compression algorithm is generally employed in compressing a document file and a program file. (e.g., Huffman Coding, Run Length Encoding, LZW, etc.)

Conversely, a lossy compression algorithm compresses data by deleting relatively insignificant parts of the data, thereby decreasing the size of the data. Thus, the compression rate of the lossy compression algorithm is much higher than the compression rate of the lossless compression algorithm, but it is impossible to perfectly restore compressed data to the original data. Thus, the lossy compression algorithm is generally employed in compressing audio and video files. (e.g., JPEG, MPEG, etc.)

In the conventional thin client network system, the data compression is performed by the lossless compression algorithm. However, because the size of data compressed by the lossless compression algorithm is relatively large, a transmission speed is relatively low. Particularly, in a case of a real time moving picture, reproduction of the real time moving picture is not smooth because of the relatively low transmission speed.

There is a need for a data transmission system and method which provides for higher transmission rates in a thin client network.

### SUMMARY OF THE INVENTION

Accordingly, the present invention has been made keeping in mind the above-described shortcomings and a user's need for higher data transmission rates in a thin client system.

An object of the present invention is to provide a thin client network system in which a lossy compression algorithm is employed for decreasing the size of data to be transmitted from a server to a client.

Another object of the present invention is to provide a method of compressing data in a thin client network system in which a lossy compression algorithm is employed for decreasing the size of data motion picture data transmitted from a server to a client and lossless compression is employed for transmitting non-motion picture data from the server to the client.

Additional objects and advantages of the invention will be set forth in part in the description which follows, and, in part, will be obvious from the description, or may be learned by practice of the invention.

The above and other objects of the present invention are accomplished by providing a method of transmitting data in a thin client network system comprising a client, and a server connected to the client through a network, the network being provided with at least one application program, executing the application program in response to a request of the thin client, and transmitting results from the execution of the application program to the thin client as graphic data. The method comprises accessing the server through the network by the thin client; executing the application program of the server by the thin client; determining whether or not the application program activated by the thin client includes a moving picture; compressing moving picture data with a lossy compression algorithm and compressing data other than the moving picture data with a lossless compression algorithm when it is determined that the active application program includes the moving picture; and transmitting the compressed graphic data from the server to the thin client.

Preferably, the determining of whether the active application program includes the moving picture further comprises dividing a screen of the thin client into a predetermined number of cells; allocating array variables to the cells, respectively; determining whether the cells are updated when the graphic data is transmitted from the server to the thin client; increasing the array variables of the updated cells, and decreasing the array variables of the unchanged cells; and regarding the cells as containing the moving picture data when the array variables exceed a predetermined threshold value.

Preferably, the data transmitting method further comprises determining whether an inactive application program exists; and compressing the graphic data of the inactive application program with the lossy compression algorithm.

According to another aspect of the present invention, the above and other objects are also achieved by providing a thin client network system comprising a client, and a server connected to the client through a network, the server having at least one application program installed thereon, executing the application program in response to a request of the thin client, and transmitting results from the execution of the application program to the thin client as graphic data. A control part provided in the server determines whether the application program activated by the thin client includes a moving picture, and controls moving picture data to be compressed by a lossy compression algorithm and the data other than the moving picture data to be compressed by a lossless compression algorithm when a determination is made that the active application program includes the moving picture.

Preferably, the control part determines whether an inactive application program exists, and compresses the graphic data of the inactive application program with the lossy compression algorithm.

### BRIEF DESCRIPTION OF THE DRAWINGS

The present invention will be better understood and its various objects and advantages will be more fully appreciated from the following description taken in conjunction with the accompanying drawings, in which:

FIG. 1 illustrates a conventional thin client network system;

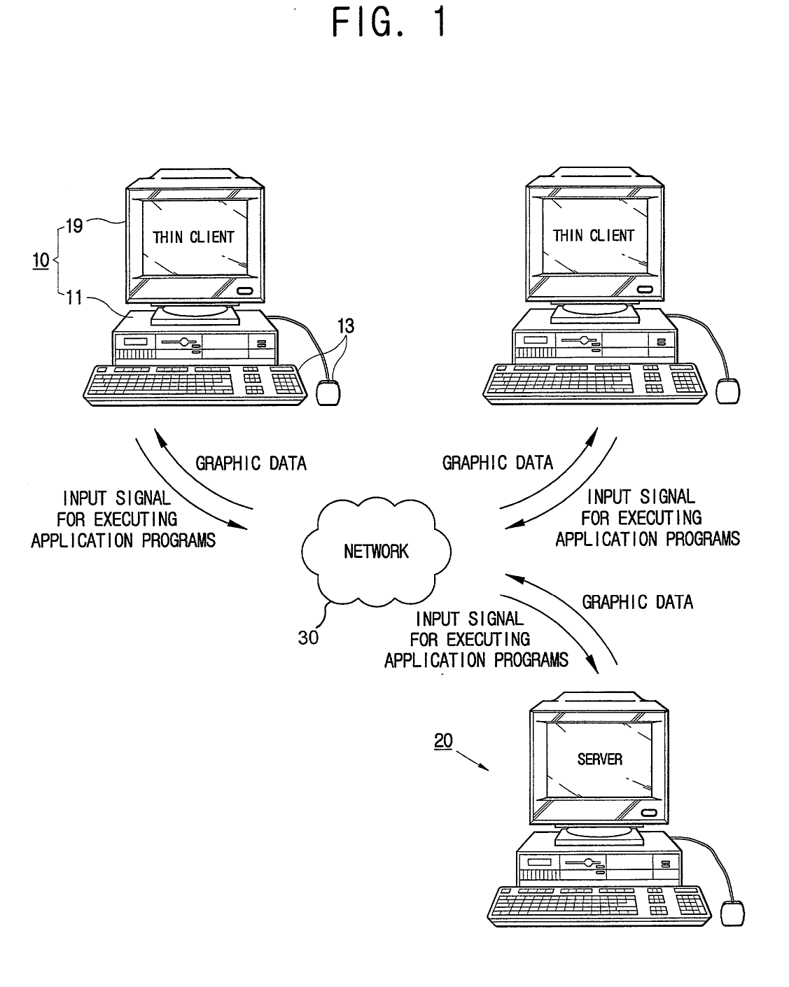

FIG. 2 is a flowchart illustrating a process of transmitting graphic data from a server to a thin client in the conventional thin client network system;

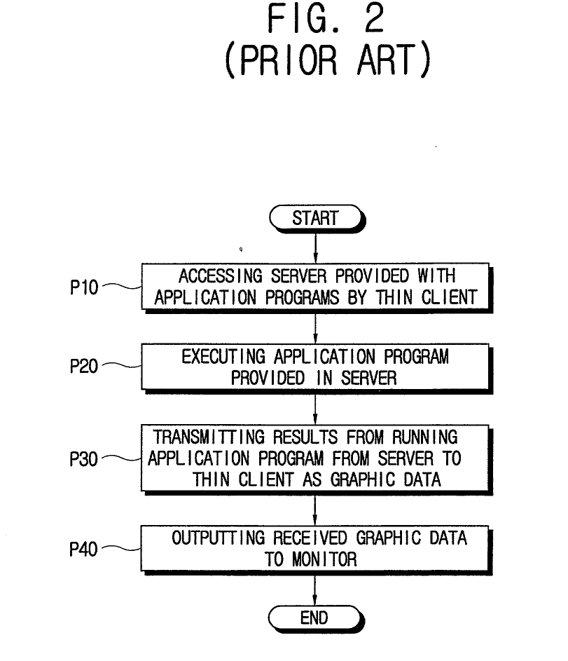

FIG. 3 is a block diagram of a thin client network system according to an embodiment of the present invention;

FIG. 4 illustrates a screen divided into cells formed with 8×8 pixels; and

FIG. 5 is a flowchart illustrating a process of transmitting graphic data from a server to a thin client in the thin client network system according to the present invention.

### DETAILED DESCRIPTION OF THE PREFERRED EMBODIMENT

Reference will now be made in detail to the present embodiments of the present invention, examples of which are illustrated in the accompanying drawings, wherein like reference numerals refer to like elements throughout.

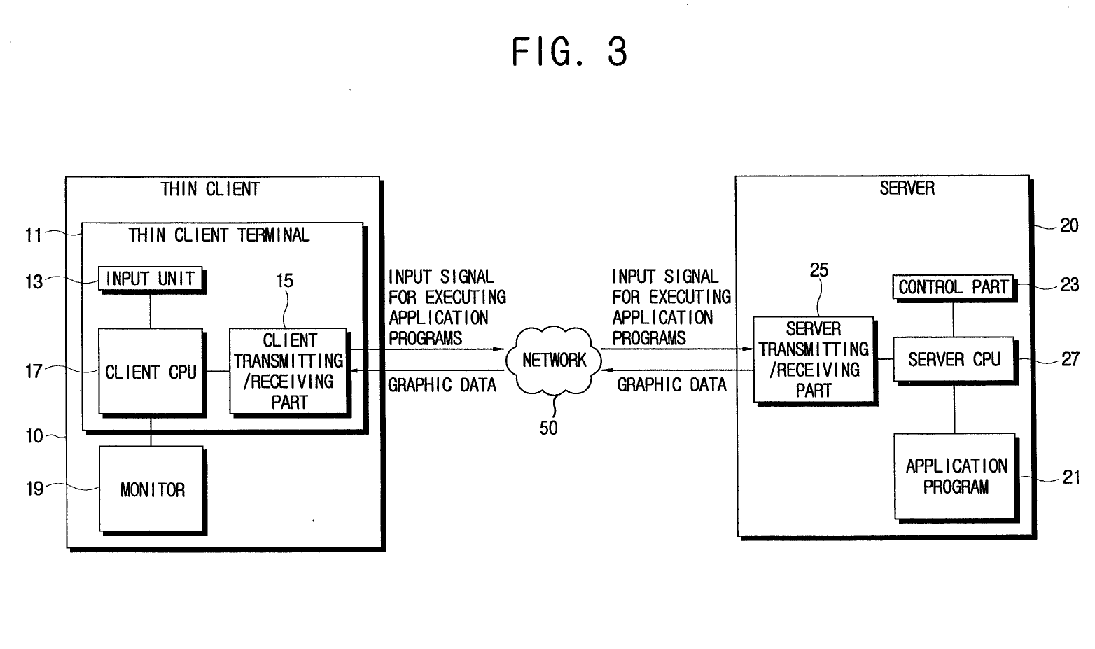

As shown in FIG. 3, a thin client network system according to an embodiment of the present invention comprises a server 20 provided with a plurality of application programs 21, and a thin client 10 connected to the server 20 by a network 50 and executing the application programs 21 such as, for example, a Window media player, a word processor, etc., through the network.

The thin client 10 includes a main body 11 equipped with a plurality of hardware components such as a client CPU (central processing unit) 17, and a monitor 19 connected to a main body 11 and displaying graphic data received from the server 20 through the main body 11.

The main body 11 is comprised of an input unit 13 such as a mouse, a keyboard, etc., which inputs an input signal to the server 20, a client transmitting/receiving part 15 which transmits the input signal to the server 20 and receives the graphic data from the server 20 through the network, and a client CPU 17 which processes the graphic data received by the client transmitting/receiving part 15 and outputs the processed data to the monitor 19.

In the thin client 10, an input signal is inputted through the input unit 13 in order to execute the application programs 21 of the server 20 connected with the thin client 10 through the network. The input signal for executing one or more of the application programs 21 is transmitted to the server 20 through the client transmitting/receiving part 15 by control of the client CPU 17.

The server 20 comprises the plurality of application programs 21 which can be run by the thin client 10 through the network 50, a server transmitting/receiving part 25 which receives the input signal from the thin client transmitting/receiving part 15 and transmits results from the execution such as computing, saving, etc., of at least one of the application programs 21 run in response to a request of the thin client 10 to the client transmitting/receiving part 15 as graphic data through the network, and a server CPU 27 which processes the application programs 21 in response to the input signal from the thin client 10 and transmits the processed data to the thin client 10 as the graphic data through the server transmitting/receiving part 25.

The server 20 further comprises a control part 23 comprised of a dedicated chip or a software program which controls an active application program 21, a moving picture or an inactive application program 21 to be compressed by a lossy compression algorithm.

The control part 23 determines whether the application program 21 is active or inactive when the server CPU 27 creates the graphic data by running the application program 21 according to the input signal from the thin client 10.

When the thin client 10 simultaneously runs a plurality of application programs 21 of the server 20 (e.g., if Internet Explorer is run together with a word processor), only one application program 21 is activated and the others are inactivated. Herein, because the inactive application programs are not presently used, compression of the graphic data of the inactive application programs by the lossy compression algorithm having a higher compression rate and lower compression quality than those of the lossless compression algorithm is of no consequence.

In order to determine whether the application program is active or inactive, the control part 23 employs a handle from a window structure of the active application program 21 through Win32API (application programming interface).

In the case of the inactive application program 21, the control part 23 controls the server CPU 27 to compress the graphic data with the lossy compression algorithm, and transmits the lossy compressed graphic data to the thin client 10.

In the case of the active application program 21, the control part 23 determines whether the active application program 21 includes a moving picture. If the active application program 21 includes the moving picture, the control part 23 compresses the moving picture data with the lossy compression algorithm and compresses the data other than the moving picture data with the lossless compression algorithm. Contrarily, if the active application program 21 does not include the moving picture, the control part 23 compresses the graphic data with the lossless compression algorithm.

For example, in the case that the active application program is a Windows media player for reproducing a moving picture, a moving picture part of the graphic data to be transmitted to the thin client 10 is compressed by the lossy compression algorithm and the graphic data other than the moving picture part is compressed by the lossless compression algorithm. Thus, contrary to the conventional thin client network system, the present thin client network system partially employs the lossy compression algorithm, thereby decreasing the size of the graphic data to be transmitted from the server 20 to the thin client 10.

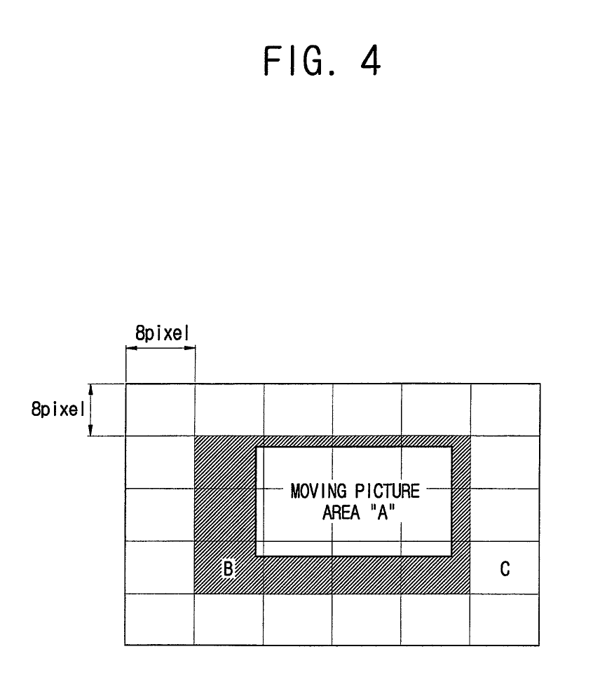

The process of determining whether an active application program includes a moving picture will be described with reference to FIG. 4.

As shown in FIG. 4, a screen is divided into cells formed with 8×8 pixels, and array variables are allocated to each cell. For example, if the screen is formed with 1024×768 pixels, the array variables of 128×96 are each allocated to the cells (e.g., unsigned char scrn_cells{128}{96}). Then, the array variables (scrn_cells{x}{y})) are initiated at “0”.

After the assignment and initialization of the array variables, while the graphic data is transmitted from the server 20 to the thin client 10, the array variables are increased by “1” whenever at least one pixel which belongs to the cells containing the graphic data is updated, and decreased by “1” whenever the pixels are not updated. For example, as shown in FIG. 4, if only an “A” area contains a moving picture, the array variables related to the cells of the “A” area are increased by “1” whenever the graphic data is transmitted from the server 20 to the thin client 10, and the array variables of the other cells, i.e., cells of a “C” area are decreased by “1” whenever the graphic data is transmitted from the server 20 to the thin client 10. The array variables of a “B” area adjacent to the “A” area are also increased by “1”, like the “A” area.

Thus, the array variables are altered whenever the graphic data is transmitted from the server 20 to the thin client 10, so that if the array variables exceed a predetermined threshold value (e.g. threshold value: 5), the exceeding of the threshold signifies that the cells related to the array variables are continuously updated, thereby regarding the cells as containing the moving picture data.

In the cells regarded as the moving picture data, the graphic data is compressed by the lossy compression algorithm. Oppositely, in the cells regarded as the non-moving picture data, the graphic data is compressed by the lossless compression algorithm. Thereafter, the compressed graphic data is transmitted to the client transmitting/receiving part 15 by the server CPU 27 through the server transmitting/receiving part 25, and outputted to the monitor 19 of the thin client 10.

If the predetermined threshold value is too small, a little change of the screen will be regarded as the moving picture, and if the predetermined threshold value is too large, the moving picture may be compressed by the lossless compression algorithm. Therefore, the threshold value is automatically adjustable according to the load of the network, or manually adjustable by a user.

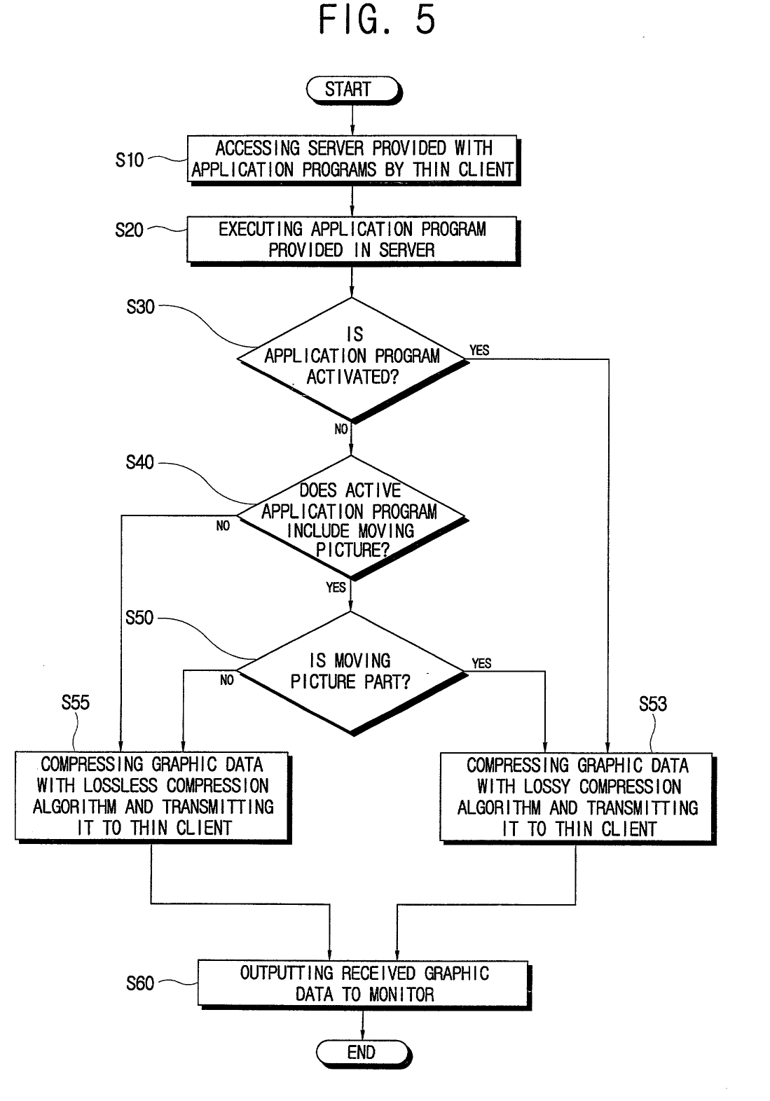

In the thin client network system according to the present invention, the process of transmitting the graphic data from the server 20 to the thin client 10 will be described referring to FIG. 5.

The thin client 10 accesses the server 20 provided with the application programs 21 through the TCP/IP or IPX protocol (S10). After a simple authenticating procedure, the thin client 10 orders the application program provided in the server 20 to be executed (S20). To initiate the order, an input signal is inputted through the input unit 13 of the thin client 10, and transmitted to the server 20. Then, the control part 23 of the server 20 determines whether the application programs 21 are activated while the various application programs 21 are run (S30).

In the case of the inactive application program 21, the control part 23 controls the server CPU 27 to compress the graphic data of the inactive application program with the lossy compression algorithm, and transmits the graphic data of the inactive application to the thin client 10 (S53). The thin client 10 receives the graphic data compressed by the lossy compression algorithm in the case of the inactive application program 21, and outputs the lossy compressed graphic data to the monitor 19 (S60). Thus, because the lossy compression algorithm is applied to the inactive application program that a user does not presently use, the size of the graphic data the server 20 transmits to the thin client 10 is relatively decreased. The process of determining whether the application program 21 is activated is described above.

In the case of the active application program 21, the control part 23 determines whether the active application program 21 includes a moving picture or not (S40). If the active application program 21 includes the moving picture, the control part 23 classifies the active windows into a moving picture part and a non-moving picture part (S50). Then, the control part 23 compresses the moving picture part with the lossy compression algorithm and transmits the lossy compressed moving picture part to the thin client 10 (S53), and compresses the other part (the non-moving picture part) with the lossless compression algorithm and transmits the lossless compressed other part to the thin client 10 (S55). If the control part 23 determines that the active application program does not include the moving picture, the control part 23 compresses the graphic data of the active application program with the lossless compression algorithm and transmits the lossless compressed graphic data to the thin client 10 (S55). The transmitted data is output, to the monitor 19 (S60).

Thus, in the case that the active application program 21 includes the moving picture like the Windows media player, the lossy compression algorithm is applied to the moving picture part of the active application program 21, and the lossless compression algorithm is applied to the other or non-moving part of data provided by the application program, thereby transmitting the compressed graphic data to the thin client 10. Consequently, contrary to the conventional thin client network system, the present thin client network system partially employs the lossy compression algorithm, thereby decreasing the size of the graphic data to be transmitted from the server 20 to the thin client 10.

As described above, in the thin client network system according to the present invention, a determination is made whether application programs are activated and whether the active application program includes a moving picture, and the moving picture data is compressed by a lossy compression algorithm and transmitted to a thin client, thereby decreasing the size of the graphic data to be transmitted to the thin client.

As described above, the present invention provides a thin client network system in which the size of data to be transmitted from a server to a client is efficiently decreased.

Although embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A method of transmitting data in a thin client network system comprising a thin client, and a server connected to the thin client through a network, the server being provided with at least one application program, the server activating and executing an application program in response to a request of the thin client, the method comprising:
determining whether the activated application program includes moving picture data;
compressing the moving picture data with a lossy compression algorithm and nonmoving picture data with a lossless compression algorithm if a determination is made that the active application program includes the moving picture data; and
transmitting the compressed data from the server to the thin client.

2. The method according to claim 1, wherein the determining of whether the activated application program includes the moving picture data, comprises:
dividing a screen of the thin client into a predetermined number of cells;
allocating array variables to the cells, respectively;
determining whether the cells are updated when the compressed data is transmitted from the server to the thin client;
increasing the array variables of the updated cells, and decreasing the array variables of the unchanged cells; and
regarding the cells as containing the moving picture data when the array variables exceed a predetermined threshold value.

3. The method according to claim 1, further comprising:
determining whether an inactive application program exists; and
compressing the graphic data of the inactive application program with the lossy compression algorithm.

4. A thin client network system comprising:
a network;
a thin client;
a server connected to the thin client through the network, the server provided with at least one application program, the server activating and executing an application program in response to a request of the thin client, and transmitting results from the execution of the application program to the thin client; and
a control part provided in the server, and which:
determines whether the application program activated by the thin client includes moving picture data, and
controls the moving picture data to be compressed by a lossy compression algorithm and non-moving picture data to be compressed by a lossless compression algorithm in response to the determination that the activated application program includes the moving picture data.

5. The thin client network system according to claim 4, wherein:
the server is provided with a plurality of application programs; and
the control part:
determines whether one of the plurality of application programs is inactive, and
compresses data of the inactive application program with the lossy compression algorithm.

6. The method according to claim 2, wherein the predetermined threshold is automatically adjustable according to a load of the network.

7. The method according to claim 2, wherein the predetermined threshold is manually adjustable by a user.

8. A server for executing a client request in a thin client network, the server comprising:
an application program;
a central processing unit which runs the application program in response to a client request; and
a control part which:
determines whether a result of running the application program requested by the thin client includes moving picture data, and
controls compression of the moving picture data by a lossy compression algorithm and compression of non-moving picture data by a lossless compression algorithm, if the determination is made that the requested application program includes the moving picture data,

9. A method of operating a server in a thin client network, the method comprising:
receiving a request to activate an application program from a thin client;
running the application program;
determining whether a result of running the application program requested by the thin client includes moving picture data,
controlling compression of the moving picture data by a lossy compression algorithm and compression of non-moving picture data by a lossless compression algorithm, if the determination is made that the result of running the application program includes moving picture data; and
transmitting the compressed data to the client.

10. The method according to claim 9, wherein the determining of whether the result of running the requested application program includes the moving picture data comprises:
dividing a screen of the thin client into a predetermined number of cells;
allocating an array variable to each of the cells;
determining whether each cell is updated when the compressed data is transmitted from the server to the thin client;
increasing the respective array variables of the updated cells, and decreasing the respective array variables of unchanged cells; and
determining a respective cell to contain the moving picture data if the corresponding array variable exceeds a predetermined threshold value.

11. The method according to claim 9, wherein the predetermined threshold value is automatically adjustable according to a load of the network.

12. The method according to claim 9, wherein the predetermined threshold value is manually adjustable by a user.
